(19) United States
(12) Patent Application Publication
(10) Pub. No.: US 2015/0252936 A1
(43) Pub. Date: Sep. 10, 2015

(54) DEVICE FOR HOLDING A SHEET OF PAPER, A HOLDER FOR A MOBILE DEVICE AND SOFTWARE PROGRAM FOR USE WITH SUCH HOLDER

(71) Applicant: Christian KRANTZ, Ingolstadt (DE)

(72) Inventor: Christian Krantz, Ingolstadt (DE)

(21) Appl. No.: 14/425,776

(22) PCT Filed: Sep. 5, 2013
(86) PCT No.: PCT/EP2013/068402

§ 371 Date: Mar. 4, 2015

Related U.S. Application Data
(60) Provisional application No. 61/697,826, filed on Sep. 7, 2012.

(51) Int. Cl. F16M 11/04

(52) U.S. Cl. CPC F16M 11/04

(57) ABSTRACT

Device (1) comprising a base (2) for holding a sheet of paper comprising an adhesive means (8). The device may comprise an arm (3) for carrying a mobile device, wherein the base is adapted to carry a document and wherein the arm provides at least one holding portion (9) for carrying a mobile device.

### TECHNICAL FIELD

The present invention relates to a holder for a mobile device.

### BACKGROUND ART

The users of handheld devices, such as smartphones, tablet computers, mini TVs, etc. often want to fix their devices in a specified position which allows viewing the screen in an optimal angle. Other users may want to fix their mobile device on a holder in order to scan a document by means of the camera. Since traditional desktop scanners are too big, expensive and cumbersome for their occasional usefulness. They take up desk space, require to install drivers/updates and need a power source. On the other hand, there are many software-solutions for mobile devices with built in camera which allow the device to be used as a scanner. However, using such software without having a proper fixture to keep the device in place often results in poor quality out of focus scans with wrong angles and size because:
The camera has to be in the exact right distance, position and angle to the document to get quality scans. Holding the device in hand is therefore very difficult.
Even slight moves of the camera during scanning result in blurry scans.
Not having the exact same distance between device and document for each scan results in different document sizes.
Crinkled documents appear also crinkled on the scans.
Non predictable background colour makes document-border recognition difficult for the scan software. Failing in border recognition results in scans which have to be hand processed afterwards, a time consuming manual task.

A prior art device called “SCANBOX” is a portable, foldable solution. Due to its design it has the following limitations and disadvantages:
It is very shaky, consequently making it hard to take high quality non wiggly photos.
Significantly limits ambient light due to its design, which is closed on two sides. Ambient light is a very important factor for good quality scans, especially given the small objectives used in mobile devices needing much light.
Lack of fixation of the mobile device makes it hard to use, because the device has often to be readjust after touching it.
Lack of fixation for the document results in poor quality scan of crinkled documents.

### DISCLOSURE OF INVENTION

### Technical Problem

It is an object of the invention to overcome the abovementioned drawbacks.

### Technical Solution

The above mentioned problem is solved by the current invention as defined in the independent claims. Preferred embodiments are subject of the dependent claims.

The abovementioned problem is solved especially by a device comprising a base for holding at least one sheet of paper, the device comprising an adhesive means. The adhesive means is adapted to hold at least one sheet of paper, which also might be a plurality of papers arranged side by side or as a stack of papers.

In a preferred embodiment, the device further comprises an arm for carrying a mobile device, wherein the base is adapted to carry a document and wherein the arm provides at least one holding portion for carrying a mobile device. Such device is a holder for a mobile device comprising a base and an arm for carrying the mobile device, wherein the base is adapted to carry a document and wherein the arm provides at least one holding portion comprising an adhesive means to which the mobile device may be attached to. The mobile device is for example a mobile phone, a smartphone, a tablet computer, an electronic camera or the like. The mobile device comprises a camera, usually a CCD camera for taking single pictures, sequences of pictures or films. The pictures or films, respectively, are usually stored in the mobile device. Furthermore, the mobile device might comprise software for optical character recognition (OCR) and/or image editing.

In a preferred embodiment, the arm comprises means for holding or carrying, respectively, the mobile device. The means can be a clamping device or the like. In a preferred embodiment, the arm comprises an adhesive means to which the mobile device may be attached to. The adhesive means is preferably of the same or a similar material as the pad for the base. However, the adhesive means for the arm may be fixed permanently, e.g. by gluing, to the arm. Alternatively, the adhesive means may have adhesive layers on both sides so that it is attached to the arm as well as to the mobile device by adhesive effect.

In a preferred embodiment, the arm is attached to the base at an outer circumference of the base. This gives space for carrying a paper or other objects on the base.

In a preferred embodiment, the distance between the base and the first holding portion can be changed. This allows focussing and/or defining the area to be scanned by the mobile device, even if the device does not have optical equipment to do so.

In a preferred embodiment, the arm is connected to the base by a joint. This allows adjusting the arm as desired.

In a preferred embodiment, the arm comprises at least one further joint. Preferably, one joint is near the base and the other joint in a mid-area of the arm. By two joints, the upper part of the arm can be moved in two directions, this means that the upper part has two degrees of freedom. By this measure, the height of the upper part as well as the position over the base can be adapted.

In a preferred embodiment, the first holding portion is connected to the arm by a joint. This allows adapting the angle of the holding portion relative to the arm. When adapting the arm's position, the holding portion can be arranged e.g. parallel to the base.

In a preferred embodiment, the arm has a convex shape. Thus, the arm does not extend into the scanned area.

In a preferred embodiment, the holding portion is arranged in parallel to the base. This allows scanning by the mobile device in a defined position.

In a preferred embodiment, the arm further comprises a second holding portion which is bent downward to the base. The mobile device is supported in a position having an angle between 0 and 90 degree, preferably 15-45 degree relative to the base. In this position, the mobile device can be used e.g. for watching films or pictures or for video conferences or the like. The mobile device is supported in a position having an angle relative to the base.

In a preferred embodiment, the second holding portion is connected to the first holding portion or the arm by a joint. This allows turning the second holding portion relative to the first holding portion.

In a preferred embodiment, the holder comprises at least one illumination source. The illumination source is preferably at least one LED. The illumination source is used for illuminating the base or parts thereof.

In a preferred embodiment, the first holding portion and/or the second holding portion comprise an adhesive means. The mobile device can be attached to the holding portion using the dry adhesive effect.

In a preferred embodiment, the adhesive means comprises at least one adhesive layer. The adhesive means is preferably made of a flexible material having a (micro-) fine structured surface. Preferably, the material is a polymer or a mixture of polymers. The surface is given a structure, preferably by a printing process, so that the surface is able to use a so called dry adhesive effect when contacting another surface. In the following, adhesive effect is especially understood as dry adhesive effect. Such materials are e.g. known as “nano-pad” and distributed e.g. by company INOTEC Europe. The adhesive layer can be of the same material as a substrate or base layer carrying the adhesive layer or can be of a different material. Both embodiments are subject of the invention.

In a preferred embodiment, the adhesive means comprises two adhesive layers. In a preferred embodiment, the adhesive means is a pad having a mid layer which is covered on both sides by an adhesive layer. This means that both sides of the adhesive means are adapted to make of use the above mentioned adhesive effect. The pad is applied to the base by using the adhesive effect and can be removed from the base. This allows using both sides of the pad.

In a preferred embodiment, the two adhesive layers have different colours. Preferably, one of the colours is grey. A defined and preferably dark colour allows a software recognition of the borders of a sheet of paper due the contrast between the white sheet of paper and the background.

In a preferred embodiment, one of the adhesive layers has a colour adapted to perform a chroma keying, preferably a bluebox or greenbox keying. This allows an easy cropping, extracting or cutting of a scanned object by manual or automatic chroma keying.

In a preferred embodiment, the adhesive means is a nano structured adhesive layer or comprises at least one nano structured adhesive layer.

In a preferred embodiment, the nano structure comprises a plurality of stamps arranged on a substrate. In a preferred embodiment, at least a part of the stamps comprise a cavity. The nano structure, i.e the stamps, cavities and the like, is manufactured by printing a fine structure to the surface of a substrate mad of a polymer or a mixture of polymers. In a preferred embodiment, the stamps have a height h of about 5-15 μm, preferably about 10 μm, a diameter d of about 1-5 μm, preferably about 2 μm and distances s between two stamps of about 5-10 μm, preferably about 7.5 μm.

The above-mentioned problem is also solved by use of an adhesive pad according to any of the preceding claims for fixing and/or flatening of a sheet of paper, especially for scanning the contents of the paper.

The above-mentioned problem is also solved by a computer program for a mobile device used with a device or holder according to any of the preceding claims, where the software comprises means for performing a white balance or a colour balance, where the white or colour balance is performed when a camera of the mobile device has a direct view on the adhesive layer having a colour adapted to perform a white balance. As the colour and especially the colour temperature of the pad on the base of the holder is known, this value can be permanently stored in the mobile device's memory. Then, white balancing may be performed automatically by the mobile device when it is applied to the holder.

The above-mentioned problem is also solved by a computer program for a mobile device used with a device or holder according to any of the preceding claims, where the software comprises means for automatically cutting a depicted element from the surrounding. The software “knows” the edges of an object because the background has a defined colour (e.g. blue-box or green-box). This allows automatic cutting free of the object from the background. The chroma keying is performed when a camera of the mobile device has a direct view on the adhesive layer having a colour adapted to perform chroma keying. As the colour and especially the colour temperature of the pad on the base of the holder is known, this value can be permanently stored in the mobile device's memory. Then, chroma keying may be performed automatically by the mobile device when it is applied to the holder.

The above-mentioned problem is also solved by a computer program for a mobile device used with a device or holder according to any of the preceding claims, where the software comprises means for automatically detecting boundaries of a document. This simplifies scanning of documents. The border recognition is performed when a camera of the mobile device has a direct view on the adhesive layer having a colour adapted to perform border recognition. As the colour and especially the colour temperature of the pad on the base of the holder is known, this value can be permanently stored in the mobile device's memory. Then, border recognition may be performed automatically by the mobile device when it is applied to the holder.

The above-mentioned problem is also solved by a computer program for a mobile device used with a device or holder according to any of the preceding claims, where the software comprises means for automatically improving the picture quality by using a reference picture taken without an object located on the base of the holder. The reference picture is taken prior to or after taking a picture of an object on the base.

The above-mentioned problem is also solved by computer program for a mobile device used with a device or holder according to any of the preceding claims, where the software comprises means for automatically switching between scanning a document and taking a photography followed by cutting the photographed element from the surrounding depending on the color of the pad on the upper side of the pad. By choosing the side of the pad which is visible (upper side), a user at the same time switches the mobile device between scanning (maybe with OCR afterwards) and taking a picture of an object.

The above-mentioned problem is also solved by a computer program for a mobile device used with a device or holder according to any of the preceding claims, where the software comprises means for controlling the shape and/or size of an area to be photographed or scanned by a camera of the mobile device by means of recognizing gestures of a person using the mobile device, where the gestures are filmed by the camera. In a preferred embodiment, the gestures define two opposing points of a rectangular area to be scanned or photographed. The area to be scanned or photographed can be easily defined by using gestures like pulling apart two fingers or both hands in the distance between the object or document, respectively, and the mobile device.

The device according to the invention provides a sturdy multifunctional holder that allows using almost any mobile device with a camera to take amazing high quality scans fast and easy using hi-tech micro-suction technology to keep the device and the document exactly in place. The solution is also a convenient hands-free holder for a mobile device to keep it in the perfect angle and height for watching videos, making video-conference calls or any similar hands-free use. Compared to well-known holder for mobile devices, the holder according to the invention may comprise one or more of the following features:
a. Allows to fix the mobile device in a horizontal position to make photos or videos of any object placed on the document carrier.
b. Micro-suction technology to fix the mobile device securely in place.
c. Micro-suction technology to fix and flatten crinkled documents for scanning.
d. Provides a document carrier.
e. The document carrier has a predictable, homogenous color: scan software can be calibrated to it in order to securely recognize document borders, eliminating the need of manually post processing the scans.
f. Carefully chosen materials and design to attract design oriented consumers and provide a high quality product experience.
g. No moving parts: no fiddling around, easy use, clean design, long lifetime.
h. Due to its design and the micro-suction technology to fix the mobile device no limitation to a certain device and only very little limitations to the shape and size of the device. Can be used comfortably with iPhone, iPod or other smartphones (even with case on) with a smooth flat hard surface on the back.
i. Can also be used as hands-free holder for mobile devices, while the device can be placed either horizontally or vertically and in portrait or landscape orientation on the micro-suction pad.

Anyone who does not own a scanner or prefer to use a mobile device to make scans of documents may use the holder. Unlike an electronic scanner, it doesn't require a power source or connection to a PC. The holder also may have many other uses:
a. Scans 3D objects (i.e. eBay product shots).
b. Scan a page from a book.
c. Turns a mobile device with a camera into a photocopier.
d. Live projector for presentations.

The device according to the invention is designed as a holder for a mobile device such as a cellular phone, a handheld computer, a music player, a digital camera, a tablet computer, a mini TV or any other handheld device.

The holder comprises a base and a supporting arm extending from the base and having at least one portion which is adapted to hold a mobile device.

In an embodiment of the invention, the base has a plane or flat upper surface which is adapted to carry an object, in particular a document, such as a sheet of a letter-type or DIN A4 paper, among others. The dimensions of the carrier preferably correspond to the size of the document to be carried and may be at least 210 mm×297 mm (DIN A4) or at least 114 mm×162 mm (C6).

The upper surface of the base preferably extends in a horizontal direction. However, the surface may also be arranged under an inclined angle relatively to the horizontal.

According to an embodiment of the invention, the upper surface of the base may be provided with an adhesive means for holding a document. The adhesive means may comprise a so-called micro suction pad or the like to which the document may be attached to. Micro suction tape is well known and available on the market.

### BRIEF DESCRIPTION OF DRAWINGS

FIG. 1 shows a three dimensional view of an embodiment of a holder according to the invention;

FIG. 2 shows a side view of the mobile holder according to FIG. 1;

FIG. 3a shows the holder according to FIG. 1 with a mobile phone attached to the holder in a first position;

FIG. 3b shows the holder according to FIG. 1 with a mobile phone attached to the holder in a second position;

FIG. 4 shows an adhesive pad for the base in a sectional view;

FIG. 5 shows an adhesive pad for the arm in a sectional view;

FIG. 6 shows a structure of an embodiment of the adhesive layer;

FIG. 7 shows a top view before bending showing the shape for cut;

FIG. 8 shows a three dimensional view of the second embodiment of a holder according to the invention;

FIG. 9 shows a three dimensional view of the third embodiment of a holder according to the invention.

### MODES FOR CARRYING OUT THE INVENTION

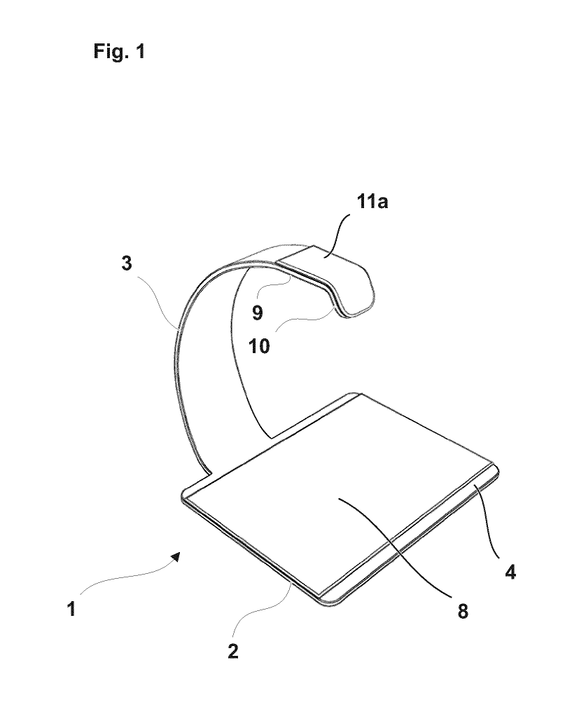

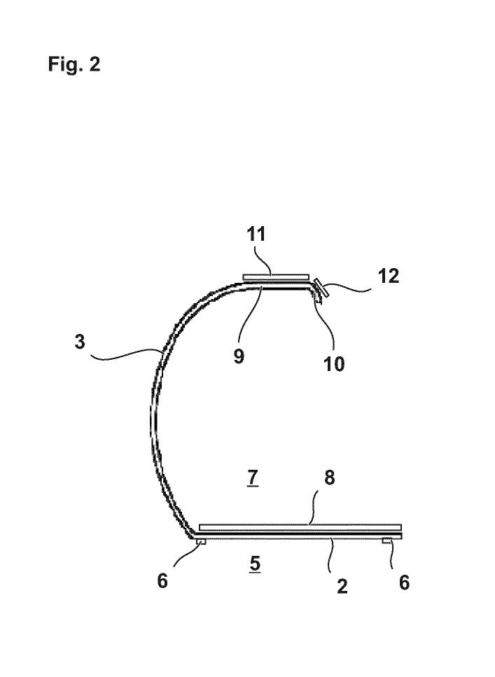

FIG. 1 shows a three dimensional view of a preferred embodiment of a holder 1 as a device according to the invention, FIG. 2 shows a side view of the mobile holder according to FIG. 1. The holder 1 comprises a base 2 and an arm 3. The base 2 serves as a stand for the device and at the same time comprises means for holding a sheet of paper. The base 2 comprises basically a flat area 4. A bottom 5 of the base 2 comprises pedestals 6 e.g. by means of rubber badges, see FIG. 2. The upper side 7, which faces the arm 3, is adapted to receive a first pad 8. The first pad 8 has at least one side which is adapted to be adhesive and thus forms an adhesive layer or which furnished with an adhesive layer. Preferably, both sides of the first pad are furnished with an adhesive layer. The pad 8 will be described later.

According to a preferred embodiment of the invention, the arm 3 is provided with at least two holding portions 9, 10 to which a mobile device may be attached to. Thereby, a first holding portion 9 is provided to hold the mobile device in a position basically parallel to the upper surface of the base and a second holding 10 portion which is provided to hold the mobile device in a sloped position. As can be seen, the first holding portion 9 is designed to keep a mobile device in position at a defined and preferably optimum distance from the base 2 for taking photos or making videos of an object placed at the top of the base. The second position defined by the second holding portion 10 is designed to keep a mobile device in a position for viewing the screen of the device. The first holding portions 9 is preferably furnished with an adhesive means, preferably a second adhesive pad 11, which comprises preferably a micro suction layer which allow the mobile device to be attached to. The second holding portions 10 is preferably furnished with an adhesive means, preferably a second adhesive pad 12, which comprises preferably a micro suction layer which allow the mobile device to be attached to. The second and third adhesive pad may be a single adhesive pad 11a which covers the first holding portion 9 and the second holding portion 10. The second and third pad will be described later in detail.

The micro suction pad typically comprises a great number of micro suction cups, each of them providing a partial amount of the total adhesive force.

The micro-suction pad allows smoothing out or flattening of wrinkled paper. It fixes the paper and keeps it smooth during the process of taking photos of it.

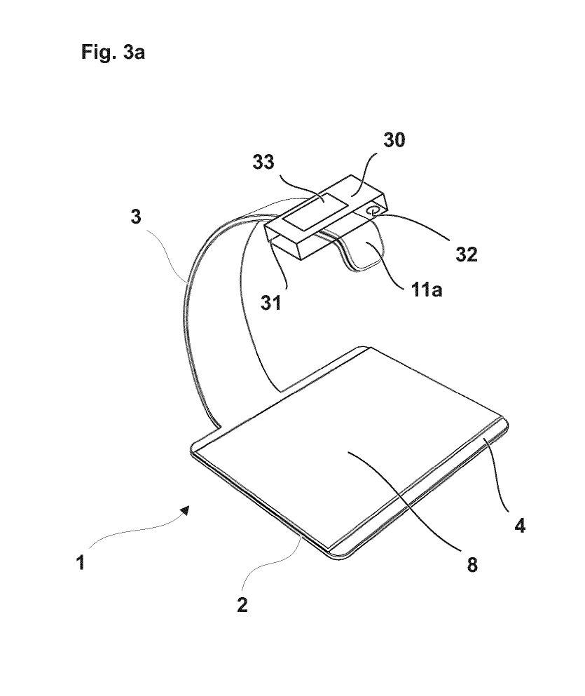

FIG. 3a shows the holder according to FIG. 1 with a mobile phone 30 as an example of a mobile device is attached to the first holding portion 9. The second adhesive pad 11a holds and fixes the mobile phone 30 in the attached position. The mobile phone comprises a camera 32 which is located near an edge 31 of the mobile phone 30 and is thus not covered by the holding portion 9 when the mobile phone is placed on the first holding portion in an orientation that the camera looks in the direction of the base 2. In this position, an object placed on the base 2 or a sheet of paper placed on the base 2 and fixed by the first pad 8 is scanned or photographed, respectively.

When the mobile phone is attached to the second holding portion 10 as depicted in FIG. 3b, a display 33 of the mobile phone 30 is visible from a viewing position in front of the holder 1 which is indicated by an arrow 34.

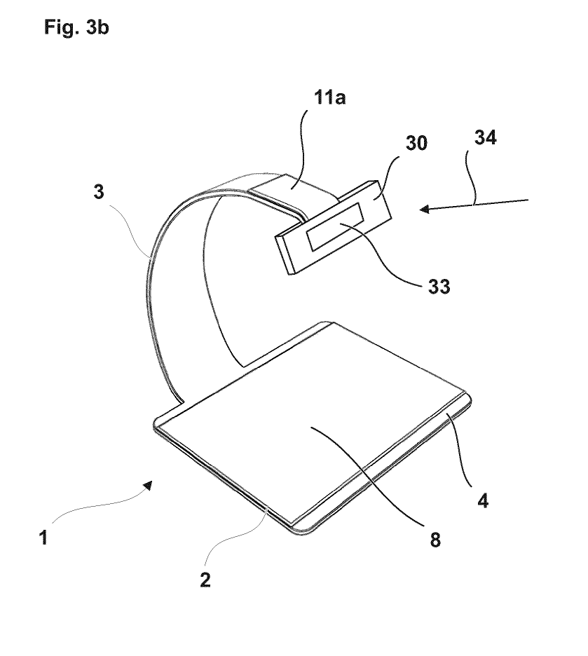

FIG. 4 shows an embodiment of a first adhesive pad 8 for the base in a sectional view. The pad comprises a mid layer 13 which is furnished on both sides with an adhesive layer 14a and 14b, respectively. The adhesive layers 14a, 14b have different colours. The adhesive layer 14a has a colour which allows blue-box (bluescreen) or green-box (greenscreen) photography of an object located on the adhesive layer 14a. This technique is also known as chroma keying. Typically, this is a blue or green colour. The other adhesive layer 14b has e.g. a white or grey colour to allow white balancing.

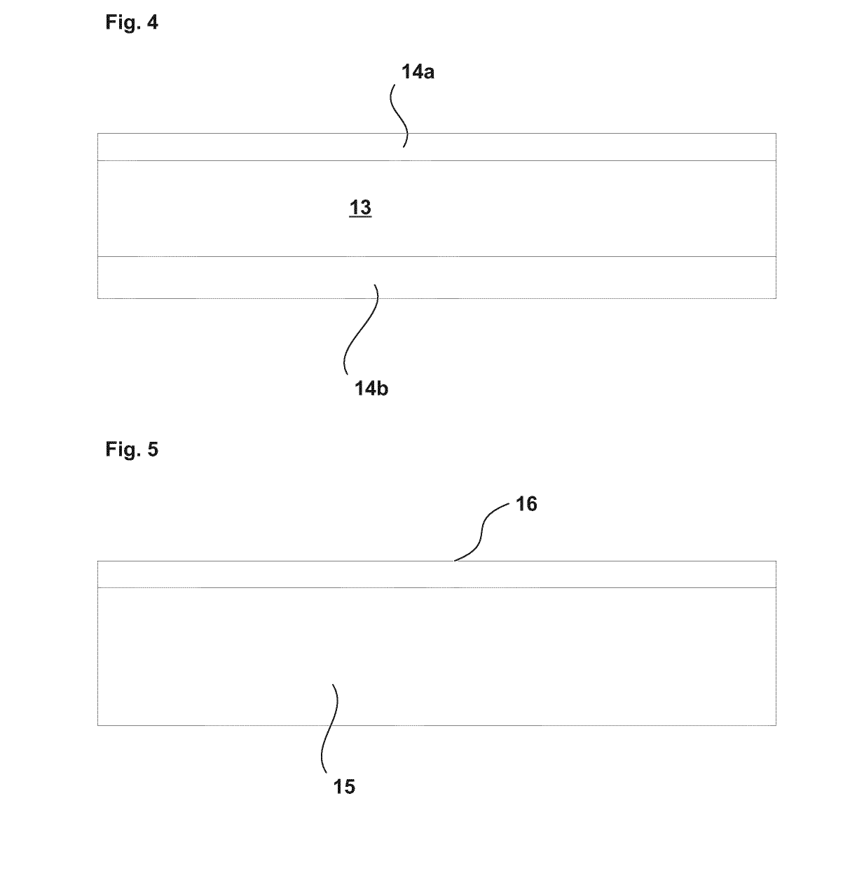

FIG. 5 shows an example of a second or third adhesive pad 11, 12 for the arm 2 in a sectional view. The pad 11, 12 comprises a base layer 15 and an adhesive layer 16. The adhesive layer 16 is preferably made of the same material as the first and second adhesive layers of the first adhesive pad. The adhesive layer 16 is used for holding a mobile device 30 comprising a camera for taking photos and/or film sequences. The holder 1 carrying a mobile device is depicted in FIGS. 3a and 3b.

The first, second and third adhesive pad each may have one or two adhesive layers as disclosed in the embodiments of adhesive pads described above.

The second and/or third adhesive pad 11, 12 are attached to the holding portions 9, 10 e.g. by bonding or the like. Alternatively, the second and/or third adhesive pad 11, 12 have a layer sequence as the first adhesive pad 8, i. e that both sides of the base layer 15 are furnished with an adhesive layer, so that the second and/or third adhesive pad 11, 12 can be attached to the respective holding portions 9, 10 by means of the adhesive effect.

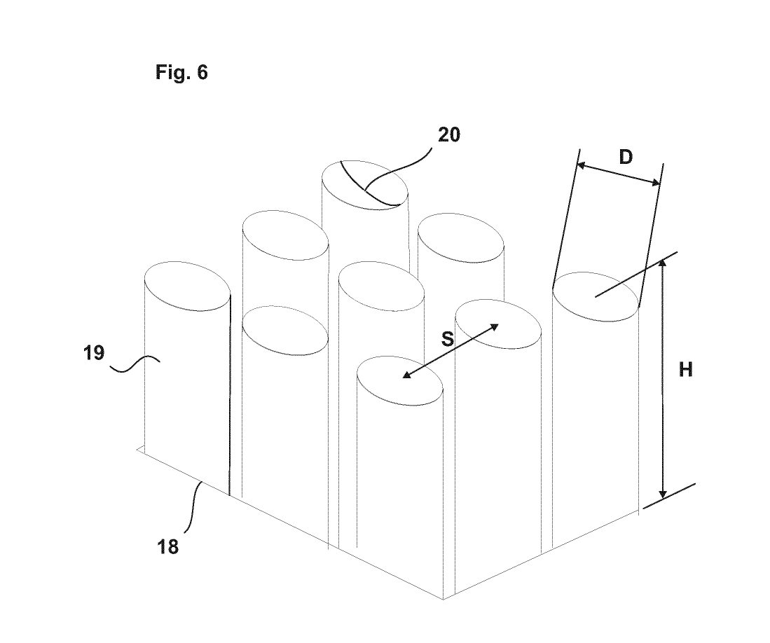

FIG. 6 shows a micro structure of an embodiment of the adhesive layer. A substrate 18 comprises very small stamps 19. The stamps 19 may be provided with cavities 20. Such structures are e.g. known as “nano-pad” and distributed e.g. by company INOTEC Europe.

According to a preferred embodiment of the invention, the base 2 and the arm 3 are manufactured in a single piece. Provided that the material of the holder is bendable, the arm 3 may be just bent upward so as to extend from the base 2 in a given direction. According to an embodiment of the invention, the arm 3 may be articulated. Thus, the arm 3 may be pivoted relatively to the base 2. The arm 3 generally may comprise one or more hinges. For instance, the second holding portion 10 may be hinged to the first holding portion 9 of the arm 3 so that the angle of inclination of the second holding portion 10 may be adjusted by the user.

According to another embodiment of the invention, the arm 3 is made flexible. Further, the arm 3 may be extendable. To this end, the arm 3 may comprise a telescope mechanism or any other extendable mechanism. Thereby, the distance between the mobile device 30 and the base 2 is adjustable. The holder 1 according to the invention may also comprise a light source like a LED for instance for illuminating the base 2. Thereby, better quality scans may be achieved. The components of the holder may be approximately 6 mm thick, or thinner or thicker. The surface may be anodized. All edges are preferably deburred and all corners may be provided with a radius. The base may be rectangular. Its dimension may be for instance approximately 12.6 inches long and 9.5 inches wide. On the bottom side of the base there may be provided a number of rubber feet. The length of the arm may be approximately 18.5 inches, it may be trapezoidal, approximately 4 inches wide at the bottom where it connects to the base and approximately 2 inches wide on the top. Any person skilled in the art will understand that the materials and dimensions mentioned above are arbitrary and may be chosen as appropriate.

Appropriate types of metal are aluminum, steel, iron or a tin plate among others. Alternatively, the holder or at least a part of the holder like e.g. the arm may be made of a plastic material.

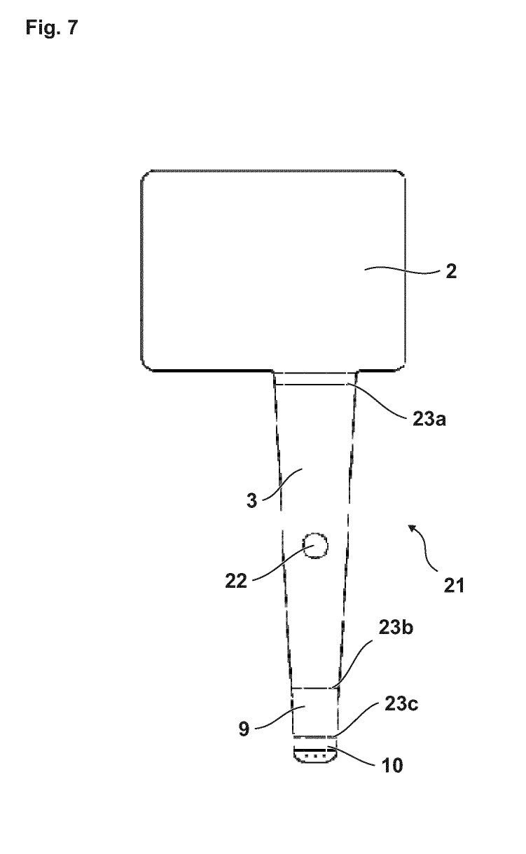

FIG. 7 depicts a top view of a metal workpiece comprising the base 2, arm 3 with first and second holding portion 9, 10 before bending. The drawing shows the shape for cut including corners provided with a radius, the position of an opening 22 which serves as a cable aperture, the positions (marked as lines 23a, 23b and 23c) of the future bending, the position of the base 2 (document carrier), the position of the first and the second holding portions 9, 10.

For manufacturing the holder 1, a metal sheet 21 as depicted in FIG. 7 is bent several times. The sheet 21 is a development of the holder 1. Starting from the base, the supporting arm extends upwards and then in approximately 11.5 inches distance parallel to the base, is slightly offset from the center of the base. There may be an aperture approximately at the mid of the supporting arm that serves as a cable guide. According to a special embodiment of the invention, the last four inches of the upper end of the supporting arm serve as the first holding portion. The last section of the supporting arm may be approximately one inch long. In the Figures the last section is bent downward in an angle of about 70 degree to the base. This section serves as the second holding portion. The second holding portion is designed to keep a mobile device in upright position for hands-free use. The mobile device can be placed on both holding portions either in landscape or portrait orientation.

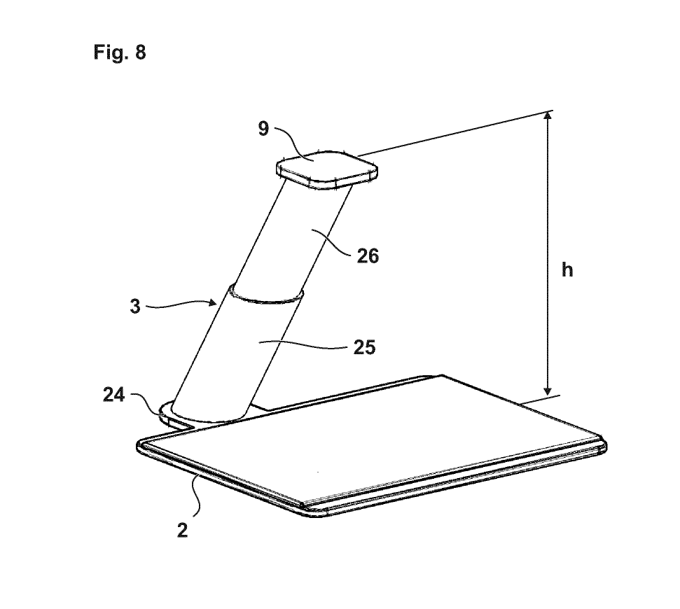

FIG. 8 shows a three dimensional view of a further preferred embodiment of a holder 1 as a device according to the invention. The embodiment differs from that according to FIG. 1 in the design of the arm 2. In the embodiment according to FIG. 8, the base 2 comprises an adapter area 24 for holding the arm 3 which is designed as a telescope arm having a first telescope part 25 and a second telescope part 26. The second telescope part 26 carries the first holding portion 9. The device according to FIG. 8 may comprise a second holding portion, which is not shown. The first telescope part 25 is a tube with an inner diameter which corresponds to the outer diameter of the second telescope part 26. The second telescope part can slide along the first telescope part in order to adjust the distance h of the holding portion 9 to the base 2. The sectional shape of the telescope parts may be circular, oval, rectangular or the like.

Between the first and second telescope part, a friction element may be arranged to prevent the second telescope arm 26 from autonomously moving driven by its own weight and/or the weight of a mobile device placed on the holding portion 9 in a lower position. Such frictional element may be a friction pad or the like.

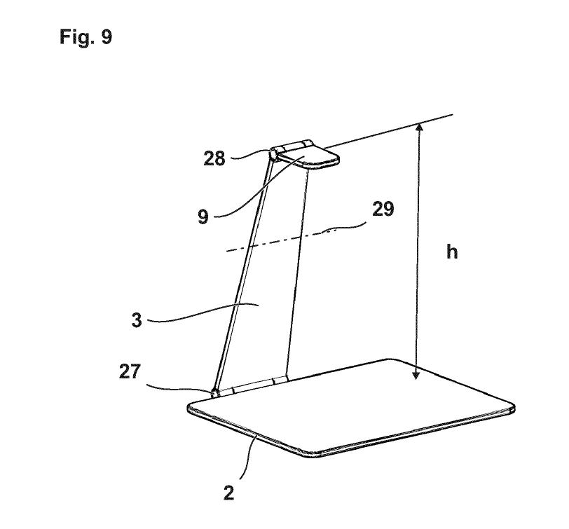

FIG. 9 shows a three dimensional view of a further preferred embodiment of a holder 1 as a device according to the invention. In this embodiment, the arm 3 is connected to the base 2 by a first joint 27. The first holding portion 9 is connected to the arm 3 by means of a second joint 28. A second holding portion (not shown) may be attached to the first holding portion by a rigid connection (like in FIG. 1) or by a third joint. Furthermore, the arm 3 may comprise a fourth joint 29, which is depicted by a joint axis in FIG. 9.

In the embodiments according to FIG. 8 and FIG. 9, the base is preferably adapted to receive a first pad 8 as described for FIG. 1. Furthermore, the first holding portions 9 is preferably furnished with a second adhesive pad 11 and the second holding portions 10 is preferably furnished with y a second adhesive pad 12 as described for FIG. 1.

The embodiments of the holder described above may be combined with each other, e.g. the arm may be a telescope arm and the first holding portion 9 may be connected to the arm by means of a joint.

In a further embodiment of the invention, the mobile device used together with the holder is preferably equipped with a software for scanning documents and/or taking pictures of objects which has some additional functions adapted to the holder/device according to the invention.

The software comprises means for performing a white balance or a colour balance. The white or colour balance is performed when the camera of the mobile device has a direct view on the pad having a colour adapted to perform white balancing. White balancing may be performed automatically by the mobile device when it is applied to the holder.

In a further embodiment of the invention, the software comprises means for automatically cutting a depicted element from the surrounding. The software “knows” the edges of an object because the background has a defined colour (e.g. blue-box or green-box). This allows automatic cutting free of the object from the background.

In a further embodiment of the invention, the software comprises means for automatically detecting boundaries of a document.

In a further embodiment of the invention, the software comprises means for automatically improving the picture quality by using a reference picture taken without an object located on the base of the holder. The reference picture is taken automatically prior to or after taking a picture of an object on the base. The reference picture should have the same colour and colour temperature for each pixel. If this is not the case for a pixel, then a correction value is calculated for the pixel. This correction value is applied to the corresponding pixel of the picture taken from the object.

In a further embodiment of the invention, the software comprises means for automatically switching between scanning a document and taking a photography followed by cutting the photographed element from the surrounding depending on the colour of the pad on the upper side of the pad. According to the side of the pad which is visible (upper side), the software automatically switches between scanning (maybe with OCR afterwards) and taking a picture of an object.

In a further embodiment of the invention, the software comprises means for controlling the functions, e.g. the shape and/or size of an area to be photographed or scanned by a camera of the mobile device by means of recognizing gestures of a person using the mobile device, where the gestures are filmed by the camera. In a preferred embodiment, the gestures define two opposing points of a rectangular area to be scanned or photographed. The area to be scanned or photographed can be easily defined by using gestures like pulling apart two fingers or both hands in the distance between the object or document, respectively, and the mobile device.

### REFERENCE SIGNS

1 holder
2 base
3 arm
4 flat area
5 bottom
6 pedestal
7 upper side
8 first adhesive pad
9 first holding portion
10 second holding portion
11, 11a second adhesive pad
12 third adhesive pad
13 mid layer
14a first adhesive layer
14b second adhesive layer
15 base layer
16 adhesive layer
18 substrate
19 stamp
20 cavity
21 metal sheet
22 opening
23 bending lines
24 adapter area
25 first telescope part
26 second telescope part
27 first joint
28 second joint
29 fourth joint
30 mobile phone/device
31 edge
32 camera
33 display
34 arrow

1. Device (1) comprising a base (2) for holding at least one sheet of paper, the device comprising an adhesive means (8), and
further comprising an arm (3) for carrying a mobile device, wherein the base (2) is adapted to carry a document and wherein the arm (3) provides at least one holding portion (9) for carrying the mobile device.

2. (canceled)

3. Device according to claim 1,
wherein the arm (3) comprises an adhesive means (11) to which the mobile device may be attached to.

4. (canceled)

5. Device according to claim 1,
wherein the distance (h) between the base (2) and the first holding portion (9) can be changed.

6.-10. (canceled)

11. Device according to claim 1, wherein the arm (3) further comprises a second holding portion (10) which is bent downward to the base (2).

12. Device according to claim 1, wherein the second holding portion (10) is connected to the arm (3) or to the first holding portion (9) by a joint.

13. Device according to claim 1, further comprising at least one illumination source.

14. Device according to claim 11, wherein the first holding portion (9) and/or the second holding (10) portion comprise an adhesive means (11, 12).

15. Device according to claim 1, wherein the adhesive means (8, 11, 12) comprises at least one adhesive layer (14a, 14b, 16).

16. Device according to claim 1, wherein the adhesive means comprises two adhesive layers (14a, 14b).

17. Device according to claim 1, wherein the adhesive means (8, 11, 12) is a pad having a mid layer (13) which is covered on both sides by an adhesive layer (14a, 14b).

18. Device according to claim 16, wherein the two adhesive layers (14a, 14b) have different colours.

19. Device according to claim 16, wherein one of the adhesive layers (14a, 14b) has a colour adapted to perform a chroma keying, preferably a bluebox or greenbox keying.

20. Device according to claim 1, wherein the adhesive means (8, 11, 12) is a nano structured adhesive layer or comprises at least one nano structured adhesive layer.

21. Device according to claim 20, wherein the nano structure comprises a plurality of stamps (19) arranged on a substrate (18).

22. Device according to claim 21, wherein at least a part of the stamps (19) comprise a cavity (20).

23. Use of the device of claim 1 for fixing and/or flattening of a sheet of paper, especially for scanning the contents of the paper.

24-30. (canceled)
